(19) United States
(12) Patent Application Publication
(10) Pub. No.: US 2013/0325591 A1
(43) Pub. Date: Dec. 5, 2013

(54) METHODS AND SYSTEMS FOR CLICK-FRAUD DETECTION IN ONLINE ADVERTISING

(71) Applicant: AIRPUSH, INC., Los Angeles, CA (US)

(72) Inventor: Asher Delug, Los Angeles, CA (US)

(73) Assignee: Airpush, Inc., Los Angeles, CA (US)

(21) Appl. No.: 13/827,783

(22) Filed: Mar. 14, 2013

Related U.S. Application Data
(63) Continuation-in-part of application No. 13/623,844, filed on Sep. 20, 2012.
(60) Provisional application No. 61/654,703, filed on Jun. 1, 2012.
(60) Provisional application No. 61/654,802, filed on Jun. 1, 2012.
(60) Provisional application No. 61/672,939, filed on Jul. 18, 2012.
(60) Provisional application No. 61/698,449, filed on Sep. 7, 2012.

(51) Int. Cl. G06Q 30/02

(52) U.S. Cl. CPC G06Q 30/0248
USPC 705/14.45

(57) ABSTRACT

An ad network includes a fraud detection service to detect click-frauds. The ad network utilizes an ad campaign to primarily detect click-frauds. Using the fraud detection service, the ad network tracks a user's click independent of the click tracking performed by the ad network's API. In one embodiment, the ad network causes a click by a user on the advertisement to cause a landing page to be generated. This landing page is operated by the ad network and allows the ad network to register logistics related to the landing that results from the user's click. This information related to the landing cannot be altered by the publisher. By utilizing various statistical analyses of the two user counts of each publisher with that of the other publishers that are also monitored using the fraud detection service, the fraudulent publishers can be identified.

### CLAIM OF PRIORITY

This application is a continuation-in part to to U.S. Nonprovisional application Ser. No. 13/623,844 filed Sep. 20, 2012, which claims priority to U.S. Provisional Application Nos. 61/654,703, filed Jun. 1, 2012, 61/654,802 filed Jun. 1, 2012, 61/672,939, filed Jul. 18, 2012, 61/698,449, filed Sep. 7, 2012, 61/713, 421, filed Oct. 12, 2012, 61/760,952, filed Feb. 5, 2013, all of which are hereby incorporated by reference in their entireties.

### FIELD

Various embodiments of the disclosed facility generally relate to providing services and information to an internet user.

### BACKGROUND

Online advertising is a form of promotion that uses the Internet and World Wide Web to deliver marketing messages to attract customers. Examples of online advertising include contextual ads on search engine results pages, banner ads, blogs, rich media Ads, social network advertising, interstitial ads, online classified advertising, advertising networks and e-mail marketing, including e-mail spam. Many of these types of ads are delivered by an ad server. One major benefit of online advertising is the immediate publishing of information and content that is not limited by geography or time.

Click-through rate (CTR) is a way of measuring the success of an online advertising campaign for a particular website. The click-through rate of an advertisement is defined as the number of clicks on an ad divided by the number of times the ad is shown (impressions), expressed as a percentage. For example, if a banner ad is delivered 100 times (100 impressions) and receives one click, then the click-through rate for the advertisement would be 1%.

The three most common ways in which online advertising is purchased are CPM, CPC, and CPA. CPM (Cost Per Mille) or CPT (Cost Per Thousand Impressions) is when advertisers pay for exposure of their message to a specific audience. “Per mille” means per thousand impressions, or loads of an advertisement. However, some impressions may not be counted, such as a reload or internal user action.

CPC (Cost Per Click) or PPC (Pay per click) is when advertisers pay each time a user clicks on their listing and is redirected to their website. They do not actually pay for the listing, but only when the listing is clicked on. This system allows advertising specialists to refine searches and gain information about their market. Under the Pay per click pricing system, advertisers pay for the right to be listed under a series of target rich words that direct relevant traffic to their website, and pay only when someone clicks on their listing which links directly to their website.

CPC differs from CPV in that each click is paid for regardless of whether the user makes it to the target site. CPA (Cost Per Action or Cost Per Acquisition) or PPF (Pay Per Performance) advertising is performance based and is common in the affiliate marketing sector of the business. In this payment scheme, the publisher takes all the risk of running the ad, and the advertiser pays only for the number of users who complete a transaction, such as a purchase or sign-up.

In a typical online advertising setup, an advertiser communicates with an advertising network (or simply, an “ad network”) to disseminate advertisements according to certain criteria (e.g., definition of certain number of impressions over a certain period, the demography or contextual nature of how the advertisements should be placed, etc.). The ad network then works with hundreds of publishers (i.e., web site operators that place content in various web sites run by them) to have advertisements placed in ad spaces allocated within web sites run by the publishers.

Ad networks are routinely defrauded (e.g., by publishers) via “click-fraud.” Click fraud is a type of fraud that occurs on the internet in pay per click online advertising when a person, automated script or computer program imitates a legitimate user of a web browser clicking on an ad, for the purpose of generating a charge per click without having actual interest in the target of the ad's link. As it applies to an ad-network, click-fraud is a method of fraud by which, for example, a fraudulent publisher generates fake clicks to an API of the ad network.

### SUMMARY

In one embodiment of the invention, an ad network can implement a fraud detection service to detect click-frauds. As part of the fraud detection service, the ad network utilizes an ad campaign to primarily detect click-frauds. For example, an ad for a new car is used to primarily detect those publishers committing click-frauds instead of just marketing the new car to a potential buyer. Using the fraud detection service, the ad network tracks a user's click independent of the click tracking performed by the ad network's API. By utilizing various statistical analyses of the two user counts of each publisher with that of the other publishers that are also monitored using the fraud detection service, the fraudulent publishers can be identified. In one embodiment, by comparing the two user counts of each publisher with that of the other publishers, the ad network can flag as cheats those publishers whose two user counts vary significantly compared to the other publishers. Such a comparison allows the fraud detection service to account for expected variance between the two user counts of a given publisher due to common tracking problems associated with each of the user tracking methods.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIGS. 2A-2C depict illustrative examples of provisioning an ad-network related landing page;

FIG. 3 depicts a process that illustrates an example of a fraud detection service as introduced herein;

FIG. 4 is a high-level block diagram showing an example of the architecture for a computer system.

The headings provided herein are for convenience only and do not necessarily affect the scope or meaning of the claimed invention.

### DETAILED DESCRIPTION

### Overview

Advertising networks (or simply, “ad networks”) are entities that connect advertisers to web sites (also referred to as publishers) that want to host advertisements. An advertiser is the entity (e.g., a beverage manufacturer) that wishes to advertise their products or services. The advertiser may prefer for their advertisements to be placed in relevant market locations, or on relevant days, and in some instances, also have the advertisements served to potentially interested targets. In the world of online computing, ad networks serve as the intermediary between the advertisers and publishers. Publishers, as defined herein, are, for example, operators or administrators of a web site (e.g., an online search results provider, an online news provider, etc.) that provide content beneficial to its users (i.e., the people that log in to the web site for information). One manner in which such publishers gain revenue is by opening up portions of their web site (in most cases, in conjunction with the information posted for the users) to have advertisements displayed.

The publishers make such “ad space” available to ad networks. In some instances, the publisher may make available some context related to the information being displayed in a particular web page so as to enable the ad network to cater contextual advertisements to that particular web page. For example, in an online news article about the results of a sports event, the ad network may sense the reader's interest and have advertisements related to tickets for the sports event catered to that particular web page.

One of the key functions of the ad networks is aggregation of ad space supply from publishers and matching it with advertiser demand. As an intermediary between the advertiser and the publisher, the ad network routinely obtains requirements from an advertiser. This may include contenxtuality requirements, a specification of the number of impressions to be placed for an advertisement over a given period of time, and other such requirements. In return, the ad network causes the advertisements to be placed with publishers that are subscribed with the ad network. The ad network further collects, for example, statistical information from the publisher for reporting to the advertiser. For example, the ad network may collect, from the publisher, information on click through rates (i.e., an indication of a number of successful clicks of the advertisement) and then compute commensurate compensation for the publisher for allowing the advertisement to be published in their ad space. It is understood that any type of advertisement compensation metric, as understood by a person of ordinary skill in the art, are contemplated in this disclosure.

In most instances, the ad network uses an application programming interface (API) to communicate with, for example, the publisher or the advertiser. For example, the ad network exposes its API to a publisher, allowing the publisher to communicate (e.g., using API calls or other communication functionalities as understood by a person of ordinary skill in the art) information to the ad network or to receive advertising information from the ad network for placement of advertisements in their ad spaces. Similarly, ad networks may expose their APIs to advertisers to receive information on advertising specs or receive content related to the advertisements. In some instances, the ad networks directly expose the API to receive information on clicks or other events experienced in the publisher's ad space to make its own determination of statistics.

As introduced briefly above, ad networks are routinely defrauded (e.g., by publishers) via “click-fraud.” Click fraud is a type of fraud that occurs on the Internet in pay per click online advertising when a person, automated script or computer program imitates a legitimate user of a web browser clicking on an ad, for the purpose of generating a charge per click without having actual interest in the target of the ad's link. As it applies to an ad-network, click-fraud is a method of fraud by which a fraudulent publisher generates fake clicks to an API of the ad network. As explained above, the API, for example, is a software module utilized by the ad network to serve (i.e. provide) advertisements in the publishers' website and to track various metrics for each of the served advertisements (e.g. number of impressions for a given ad, number for clicks for the given ad, etc.).

The ad network's API module maintains a separate record for each publisher to track the advertisements served to each publisher's website and the various metrics recorded for each of the served advertisements. When calculating the various metrics, the ad network's API module receives input values, such as the IP address of the user the ad was served to, the URL of the publisher website's the ad was served from, etc., to calculate the various metrics. The input values received by the ad network's API module are generally provided by the computing device (e.g. mobile phone, desktop computer) of the user the advertisement was served to and from other sources, such as visitor-related logs (i.e. logs that track user activities on a publisher's website) from the publisher's website.

To generate more revenue, fraudulent publishers generate fake clicks to an API of the ad network. A fake click can be easily generated to an ad network's API by submitting fake, generated input values such as a user's IP address, user-agent, click URL, and any other input values required by the ad network's API. To detect click-frauds, the ad networks currently rely on server-side pattern analysis, whereby the ad networks analyze click logs to detect outliers and other abnormalities within various cross-sections of the data. For example, an ad network may notice abnormalities in CTRs (click-through-rates) in various countries (e.g. abnormally high CTRs from India and China compared to U.S. and Canada for a publisher's website) within a fraudulent publisher's data. This method of click detection is costly since it requires teams of specialized analysts, and in most cases it doesn't detect much of the click-fraud.

In one embodiment of the invention, an ad network can implement a fraud detection service to detect click-frauds. As part of the fraud detection service, the ad network utilizes an ad campaign to primarily detect click-frauds. For example, an ad for a new car is used to primarily detect those publishers committing click-frauds instead of just marketing the new car to a potential buyer. Using the fraud detection service, the ad network tracks a user's click independent of the click tracking performed by the ad network's API. By utilizing various statistical analyses of the two user counts of each publisher with that of the other publishers that are also monitored using the fraud detection service, the fraudulent publishers can be identified. In one embodiment, by comparing the two user counts of each publisher with that of the other publishers, the ad network can flag as cheats those publishers whose two user counts vary significantly compared to the other publishers. Such a comparison allows the fraud detection service to account for expected variance between the two user counts of a given publisher due to common tracking problems associated with each of the user tracking methods.

### Illustrative Environment and associated Description of Customized Resolution Functionalities

Various examples of the techniques introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this section.

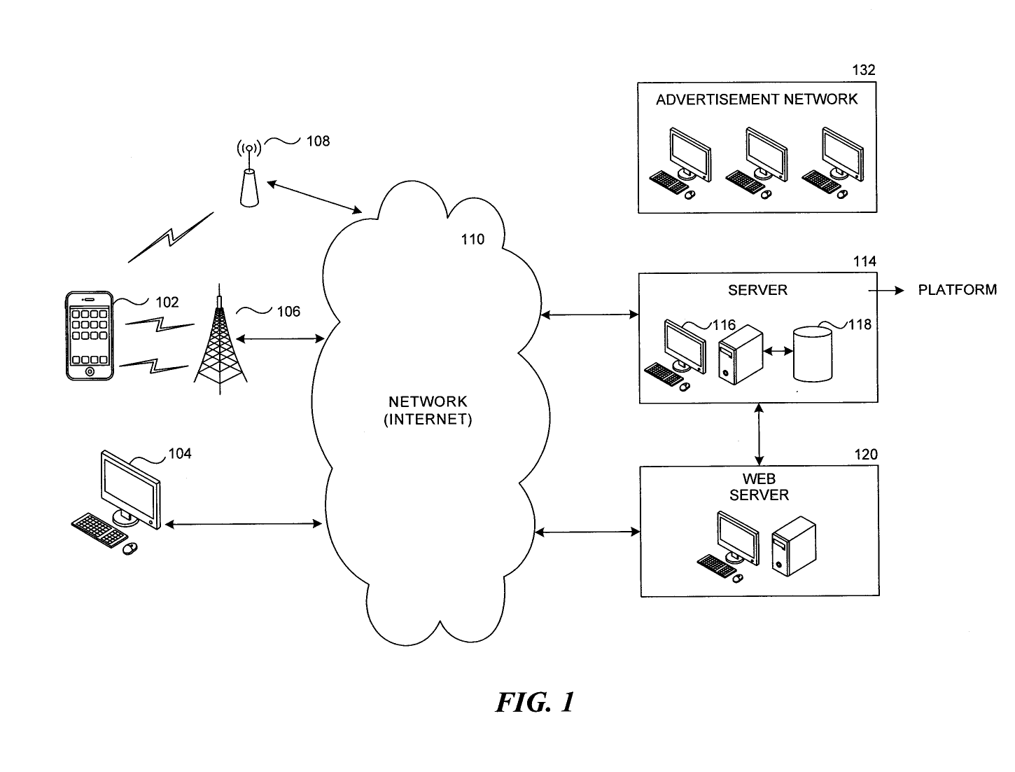

FIG. 1 and the following discussion provide a brief, general description of a representative environment in which the techniques described herein can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network (e.g., to receive a web page provided by a publisher and view any advertisements on the displayed web page). The term “phone,” as used herein, may be a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to a desired web site. In some instances, as shown in this illustrative environment, the web site may be hosted by a web server 120. In the context of this description, such a web server, or an operator of such a web server, functions as a publisher of the advertisements by virtue of receiving advertisements from an ad network and serving the advertisements within ad spaces of web pages served to users. The web server 120 may also introduce ad spaces within the web site displayed to the user and may further communicate with an ad network platform server (or simply, a “platform server”) 114 to communicate and receive advertisements to be placed in the ad spaces. As discussed above, the platform server may expose APIs that may be used by the web server to cause the advertisement to be placed in the displayed web site.

The platform server 114 may communicate, in one example, with the web server through the network 110. In one embodiment, the platform server 114 comprises a server computer 116 coupled to a local database 118. The term “platform server” as indicated herein, refers to an individual or multiple server stations or other computing apparatus. As shown in FIG. 1, in some embodiments, the personal computing devices and the web server 114 are also connected through the network 110 (e.g., the Internet). In some instances, the platform server 114 may communicate with an advertiser network 132 to receive advertisements and provide statistics related to the advertisements placed in conjunction with various publishers. The advertising network may be operated by or on behalf of the advertisers and may serve as the repository for all the information to be handled by the ad network. In some instances, the platform server 114 communicates with the advertiser network 132 via network 110 (using, e.g., API calls exposed either by the advertiser network 132 or the platform server 114).

In one embodiment, the platform server offers an ad network fraud detection service (simply, the “fraud detection service”) that is further discussed in detail throughout this description. In normal situations, as discussed above, when a user at 104 clicks on a particular advertisement served by the web server 120, the user is directed to an advertisement landing page in his terminal that has more details about the advertisement. The advertisement landing page may be a location directly serviced by, for example, the advertiser network 132, allowing the user to be directly connected to the advertiser. In return, the web server 120 (i.e., the publisher) communicates via the API to the platform server 114 (i.e., the ad network) to expose information about, for example, the click event, the IP address of the entity (i.e., the user terminal 104) that placed the click, etc. The publisher is typically compensated according to this information exposed to the ad network.

The publisher, in some instances, may be a click fraud aggressor, causing fraudulent and illegitimate click events to be fed to the ad network. However, the fraud detection service introduced herein adds further functionality to the advertisement provision process detailed immediately above to avoid such fraud instances. When a user 104 clicks on a particular advertisement, the ad network causes an additional landing page to be initiated. This additional landing page is a landing page controlled by and associated by the platform server 114 (i.e., the ad network). When the user has landed in this ad network landing page, the platform server registers that “landing” as a click event associated with the click. Since the landing page is directly controlled by the ad network, the platform server can further record instances related to the IP address of the user 104 and other such information using mechanisms known to a person of ordinary skill in the art.

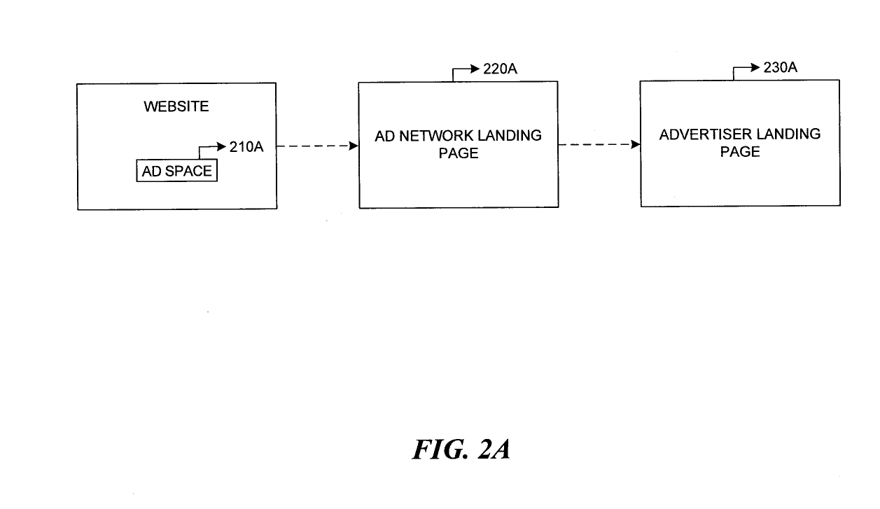

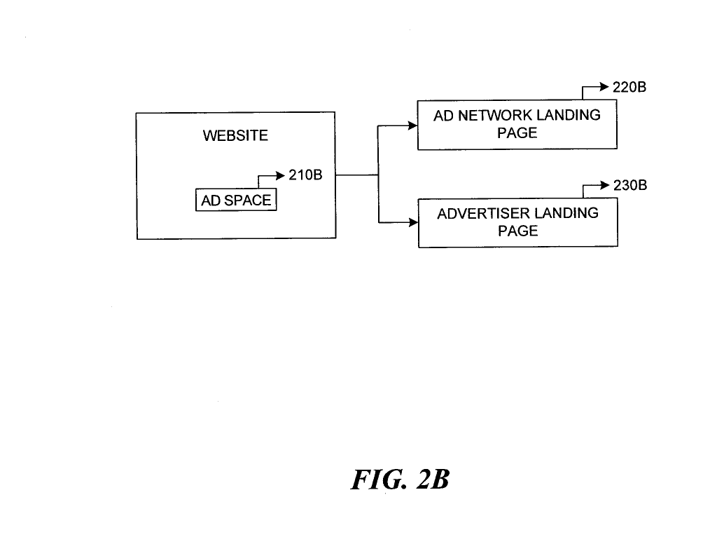

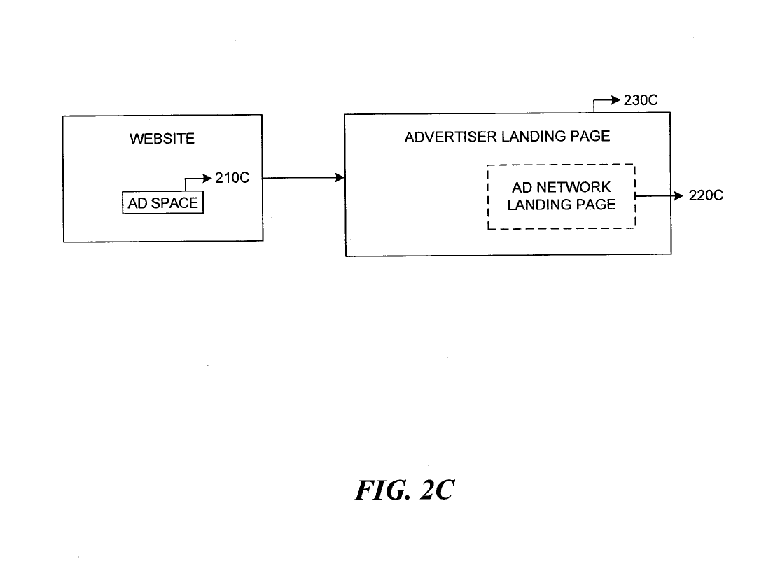

There are several mechanisms by which the ad network landing page may be integrated. Some such examples are provided, purely for the purpose of illustration, with the aid of FIGS. 2A-2C. It is understood, however, that any other examples of providing an ad network landing page in conjunction with the advertiser landing page (or providing two landing pages for that matter), as may be contemplated by a person of ordinary skill in the art, may be considered alternative or additional examples that are considered part of this disclosure.

In one example, as illustrated in FIG. 2A, when the user clicks on an advertisement 210A, the ad network landing page 220A is the first landing page of the link. This first landing page 220A may be a dummy page indicating, for example, a quick note that the user is being directed to the advertiser landing page 230A (i.e., the desired page), and then quickly change display to the advertiser landing page 230A. This way, the ad network landing page is registered, but is quickly taken away from the user's view.

In another example, as illustrated in FIG. 2B, when the user clicks on the ad link 210B, two landing pages may be caused to be opened as a result of the click. The first one, the advertisement landing page 230B, is non-transitory and is displayed to the user, while the other landing page 220B (the ad network landing page) is intended to be transitory. This other landing page 220B may, for example, close automatically before even being noticed by the user, or may otherwise be held innocuous (e.g., display dummy information related even to the relevant advertiser, display a blank page, etc.).

In some instances, as illustrated in FIG. 2C, the ad network landing page 220C may be built in within the advertisement landing page 230C in a manner that is not obtrusive to the user. As indicated above, any other examples of offering a landing page, as may be contemplated by a person of ordinary skill in the art, are also considered to be contemplated as part of this disclosure.

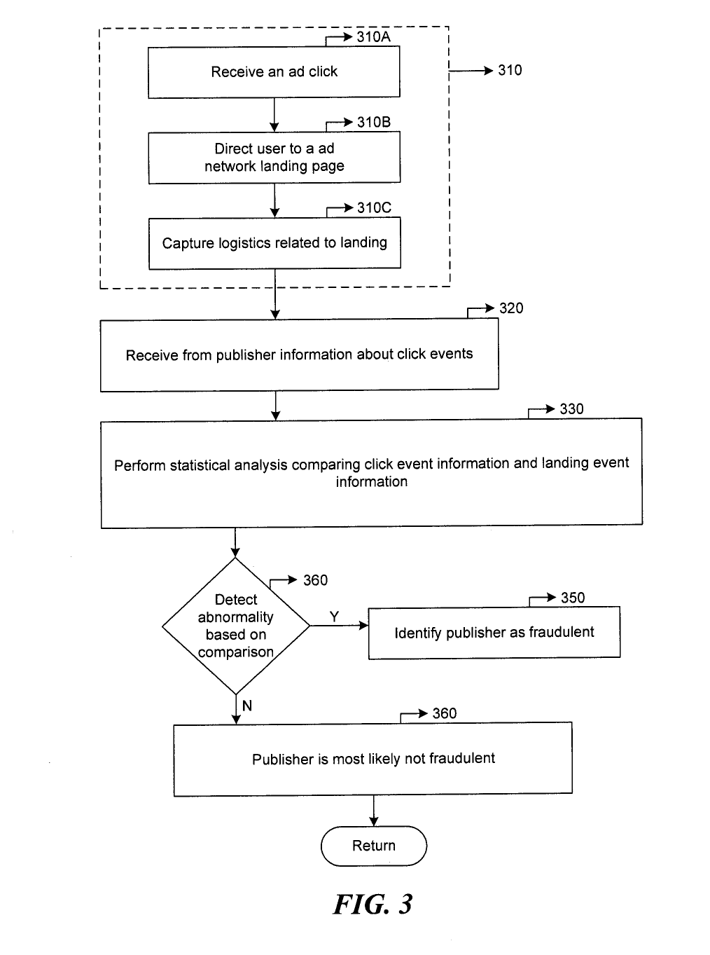

FIG. 3 now presents a flow diagram that depicts an illustrative associated with the techniques discussed herein. The process starts at step 310. Step 310 depicts a sub-process that happens in conjunction with the ad network whenever a user clicks on an ad shown on a publisher's website. In this scenario depicted here, the ads served through the ad network are configured within the fraud detection service. That is, when a user clicks on an ad, the system is configured to cause the ad to initiate a landing page associated with the ad network in addition to a regular landing page associated with the advertiser of the particular ad. Step 310 depicts the sub-process that happens every time an ad click is received.

As depicted, the sub-process starts at step 310A where a user clicks an ad. The click may directly or indirectly be reported by the publisher through, for example, an API between the publisher and the ad network. In response, as shown in step 310B, the user is directed to or is subject to a special landing page that is directly associated with the ad network. In some instances, the ad network landing page may be determined at run time by the ad network and fed through the publisher (e.g., using the API connection). In other examples, the content and location of the ad network landing page may be pre-configured in association with the ad and may be initiated without direct intervention by the ad network. Other examples of run-time or non-run-time provisioning of the ad network landing page information, as understood by a person of ordinary skill in the art, are also considered contemplated by the disclosure herein.

In addition to directing the user to the landing page, the sub-process 310 may also include a step 310C that allows the publisher to report an IP address or other such information about the click event to the ad network. It is understood that in some instances, the IP information and other click event information may be aggregated over time before being fed into the ad network system or may be done ad hoc as and when a click event happens.

At step 320, for example, the ad network receives, based on the landing page (that is controlled by the ad network) information pertinent to the landing. For example, the connecting user's IP address, time information, etc. may be logged as discussed above. This information, in one example, may be aggregated over time (as described above) and compared along with click events reported by the publisher. This is performed in step 330, for example, as a statistical analysis comparing the information submitted by the publisher (e.g., through the click events) and information gathered by the ad network from the landing page information.

At step 340, the fraud detection service analyzes the results of the statistical analysis to determine whether there is disparity between the reported click events and the landing-page aggregated information. In some instances, a substantial disparity within one publisher's click event reporting may by itself result in a conclusion that the publisher's reporting was fraudulent. In other instances, for example, the fraud detection service may compare the disparity in a particular publisher's report-out and compare that disparity against disparities computed for other publishers. In one example, if the particular publisher's disparity is an outlier in a statistical comparison with other publishers' disparities, the publisher is determined to be fraudulent. Accordingly, upon such a determination, the process identifies at step 350 that the publisher is fraudulent and initiates corresponding actions. Otherwise, at step 360, the publisher is determined to not be fraudulent and advertising continues unhindered.

### Exemplary System Architecture

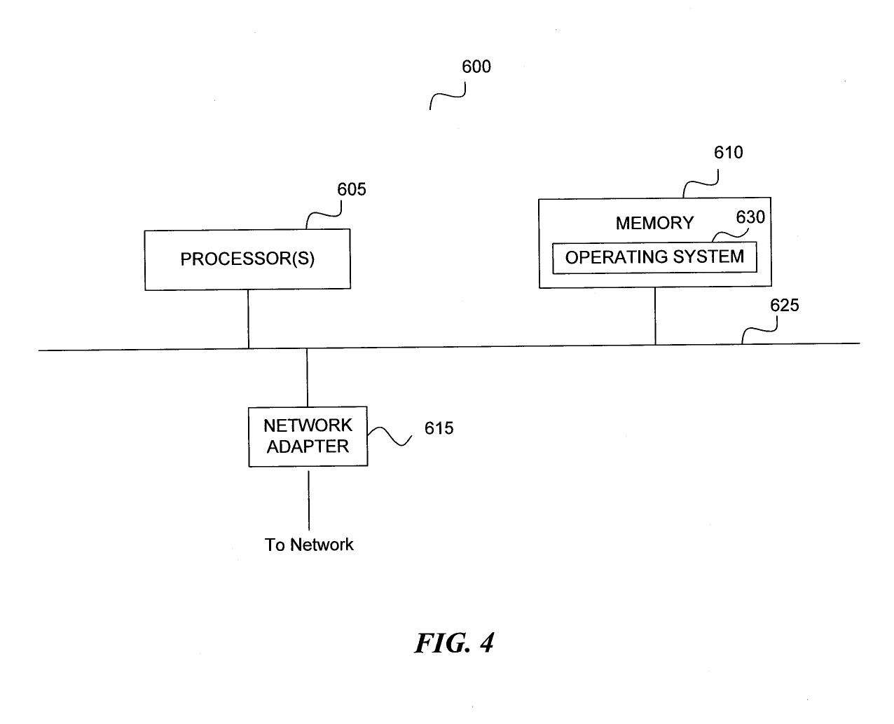

FIG. 4 is a high-level block diagram showing an example of the architecture for a computer system 600 that can be utilized to implement a platform server (e.g., 114 from FIG. 1), a web server (e.g., 125 from FIG. 1), etc. In FIG. 6, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 is or includes the main memory of the computer system 1100. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

### Generally

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of processing online advertising, the method comprising:
provisioning, by an ad network service operated in conjunction with a platform server, an advertisement to be displayed by a publisher in an ad space of a web site associated with the publisher;
causing, by the ad network service, the advertisement to include a provision for a first landing page, the first landing page being associated with the ad network service;
upon a user clicking on the advertisement in the publisher's ad space, receiving an indication of the user's redirection to at least the first landing page; and
collecting logistics based at least in part on the user's redirection to the first landing page.

2. The method of claim 1, wherein the ad network service is an intermediary between the publisher and an advertisement network, the advertisement network associated with one or more advertisers with advertising content to be distributed for display in one or more web sites associated with the publisher.

3. The method of claim 1, further comprising:
receiving, by the ad network service, an indication of a click event as reported by the publisher, the click event indicative of the user clicking on the advertisement in the ad space as reported by the publisher.

4. The method of claim 3, further comprising:
correlating the indication of the click event against at least a portion of the collected logistics;
based on an indication of non-correlation between the click event and at least the portion of the collected logistics, determining that the click event reported by the publisher is fraudulent.

5. The method of claim 1, further comprising:
collecting, over a period of time, aggregated logistics related to a plurality of redirections to the landing page as a result of one or more users clicking on the advertisement in the publisher's ad space;
receiving, over the period of time, aggregated click events as reported by the publisher over the period of time, each click event being indicative of a given user's click of the advertisement within the period of time as reported by the publisher.

6. The method of claim 5, further comprising:
correlating, by the ad network service, the aggregated logistics related to the plurality of redirections to the aggregated click events as reported by the publisher;
based on an indication of non-correlation between the aggregated logistics and the aggregated click events, determining that one or more click events reported by the publisher is fraudulent.

7. The method of claim 5, further comprising:
correlating, by the ad network service, the aggregated logistics related to the plurality of redirections to the aggregated click events as reported by the publisher;
determining a mismatch between the aggregated logistics and the aggregated click events based at least in part on the correlation.

8. The method of claim 7, further comprising:
comparing the mismatch associated with the publisher against a plurality of mismatches associated with a plurality of other publishers serviced by the ad network service;
determining whether the mismatch associated with the publisher is an outlier in relation to a statistical representation of the plurality of mismatches; and
based on an indication of the mismatch associated with the publisher being an outlier, determining that one or more click events reported by the publisher is fraudulent.

9. The method of claim 2, wherein upon a user clicking on the advertisement, the user is redirected to a second landing page, the second landing page associated with the advertising network and an extension of the displayed advertisement.

10. The method of claim 9, wherein the first landing page operates as a segue between the clicking event and the second landing page, the first landing page being displayed for an initial period of time before causing the display to be redirected to the second landing page.

11. The method of claim 10, wherein the first landing page and second landing page are substantially simultaneously initiated subsequent to the clicking event, the first landing page being displayed in the background for a given period of time.

12. A method of processing online advertising, the method comprising:
receiving, by an ad network service operated by a platform server, indication of a click event associated with a user's clicking of an advertisement in a publisher's web page, the advertisement serviced to the publisher by the ad network service, wherein the indication of the click event is as reported by the publisher;
receiving, by the ad network service, indication of a redirection from the user's terminal to a landing web page associated with the ad network service, the redirection to the landing web page being a result of the user's clicking of the advertisement, redirection information associated with the landing page being incorporated with the advertisement by the ad network service in conjunction with servicing the advertisement to the publisher;
based on an analysis of one or more indications of user's click events and one or more indications of redirections to corresponding landing web pages, determining, by the ad network service, fraudulent activity by the publisher in reporting the click events to the ad network service.

13. The method of claim 12, wherein the analysis of the one or more indications of user's click events and the one or more indications to determine fraudulent activity further includes:
collecting, over a period of time, aggregated logistics related to the one or more redirections to the corresponding landing pages;
receiving, over the period of time, aggregated click events as reported by the publisher over the period of time, each click event being indicative of a given user's click of the advertisement within the period of time as reported by the publisher.

14. The method of claim 13 further comprising:
correlating, by the ad network service, the aggregated logistics related to the one or more of redirections to the aggregated click events as reported by the publisher;
based on an indication of non-correlation between the aggregated logistics and the aggregated click events, determining that one or more click events reported by the publisher is fraudulent.

15. The method of claim 14, further comprising:
correlating, by the ad network service, the aggregated logistics related to the one or more redirections to the aggregated click events as reported by the publisher;
determining a mismatch between the aggregated logistics and the aggregated click events based at least in part on the correlation.

16. The method of claim 15, further comprising:
comparing the mismatch associated with the publisher against a plurality of mismatches associated with a plurality of other publishers serviced by the ad network service;
determining whether the mismatch associated with the publisher is an outlier in relation to a statistical representation of the plurality of mismatches; and
based on an indication of the mismatch associated with the publisher being an outlier, determining that one or more click events reported by the publisher is fraudulent.

17. A system, comprising:
at least one memory storing computer-executable instructions; and
at least one processor configured to access the at least one memory and execute the computer-executable instructions to perform a set of operations, the operations including:
provisioning, by an ad network service operated in conjunction with a platform server, an advertisement to be displayed by a publisher in an ad space of a web site associated with the publisher;
causing, by the ad network service, the advertisement to include a provision for a first landing page, the first landing page being associated with the ad network service;
upon a user clicking on the advertisement in the publisher's ad space, receiving an indication of the user's redirection to at least the first landing page; and
collecting logistics based at least in part on the user's redirection to the first landing page.

18. The system of claim 1, wherein the ad network service is an intermediary between the publisher and an advertisement network, the advertisement network associated with one or more advertisers with advertising content to be distributed for display in one or more web sites associated with the publisher.

19. The system of claim 17, wherein the operations further include:
receiving, by the ad network service, an indication of a click event as reported by the publisher, the click event indicative of the user clicking on the advertisement in the ad space as reported by the publisher.

20. The system of claim 19, wherein the operations further include:
correlating the indication of the click event against at least a portion of the collected logistics;
based on an indication of non-correlation between the click event and at least the portion of the collected logistics, determining that the click event reported by the publisher is fraudulent.

21. The system of claim 17, wherein the operations further include:
collecting, over a period of time, aggregated logistics related to a plurality of redirections to the landing page as a result of one or more users clicking on the advertisement in the publisher's ad space;
receiving, over the period of time, aggregated click events as reported by the publisher over the period of time, each click event being indicative of a given user's click of the advertisement within the period of time as reported by the publisher.

22. The system of claim 21, wherein the operations further include:
correlating, by the ad network service, the aggregated logistics related to the plurality of redirections to the aggregated click events as reported by the publisher;
based on an indication of non-correlation between the aggregated logistics and the aggregated click events, determining that one or more click events reported by the publisher is fraudulent.

23. The system of claim 21, wherein the operations further include:
correlating, by the ad network service, the aggregated logistics related to the plurality of redirections to the aggregated click events as reported by the publisher;
determining a mismatch between the aggregated logistics and the aggregated click events based at least in part on the correlation.

24. The system of claim 23, wherein the operations further include:
comparing the mismatch associated with the publisher against a plurality of mismatches associated with a plurality of other publishers serviced by the ad network service;
determining whether the mismatch associated with the publisher is an outlier in relation to a statistical representation of the plurality of mismatches; and
based on an indication of the mismatch associated with the publisher being an outlier, determining that one or more click events reported by the publisher is fraudulent.

25. The system of claim 18, wherein upon a user clicking on the advertisement, the user is redirected to a second landing page, the second landing page associated with the advertising network and an extension of the displayed advertisement.

26. The system of claim 25, wherein the first landing page operates as a segue between the clicking event and the second landing page, the first landing page being displayed for an initial period of time before causing the display to be redirected to the second landing page.

27. The system of claim 26, wherein the first landing page and second landing page are substantially simultaneously initiated subsequent to the clicking event, the first landing page being displayed in the background for a given period of time.

28. One or more computer-readable media storing computer-executable instructions that, when executed by at least one processor, configure the at least one processor to perform operations corresponding to a method for monitoring domains, the method comprising:
receiving, by an ad network service operated by a platform server, indication of a click event associated with a user's clicking of an advertisement in a publisher's web page, the advertisement serviced to the publisher by the ad network service, wherein the indication of the click event is as reported by the publisher;
receiving, by the ad network service, indication of a redirection from the user's terminal to a landing web page associated with the ad network service, the redirection to the landing web page being a result of the user's clicking of the advertisement, redirection information associated with the landing page being incorporated with the advertisement by the ad network service in conjunction with servicing the advertisement to the publisher;
based on an analysis of one or more indications of user's click events and one or more indications of redirections to corresponding landing web pages, determining, by the ad network service, fraudulent activity by the publisher in reporting the click events to the ad network service.

29. The media of claim 28, wherein the analysis of the one or more indications of user's click events and the one or more indications to determine fraudulent activity further includes:
collecting, over a period of time, aggregated logistics related to the one or more redirections to the corresponding landing pages;
receiving, over the period of time, aggregated click events as reported by the publisher over the period of time, each click event being indicative of a given user's click of the advertisement within the period of time as reported by the publisher.

30. The media of claim 29, wherein the method further comprises:
correlating, by the ad network service, the aggregated logistics related to the one or more of redirections to the aggregated click events as reported by the publisher;
based on an indication of non-correlation between the aggregated logistics and the aggregated click events, determining that one or more click events reported by the publisher is fraudulent.

31. The media of claim 30, wherein the method further comprises:
correlating, by the ad network service, the aggregated logistics related to the one or more redirections to the aggregated click events as reported by the publisher;
determining a mismatch between the aggregated logistics and the aggregated click events based at least in part on the correlation.

32. The media of claim 31, wherein the method further comprises:
comparing the mismatch associated with the publisher against a plurality of mismatches associated with a plurality of other publishers serviced by the ad network service;
determining whether the mismatch associated with the publisher is an outlier in relation to a statistical representation of the plurality of mismatches; and
based on an indication of the mismatch associated with the publisher being an outlier, determining that one or more click events reported by the publisher is fraudulent.
